(19) United States
(12) Patent Application Publication
(10) Pub. No.: US 2002/0134797 A1
(43) Pub. Date: Sep. 26, 2002

(54) Dispenser for a cleaning medium

(75) Inventors: Michael Grimm, Munderkingen (DE); Helmut Baur, Unteressendorf (DE)

Correspondence Address: MARSHALL, GERSTEIN & BORUN, 6300 SEARS TOWER, 233 SOUTH WACKER, CHICAGO, IL, 60606-6357, US

(73) Assignee: Kaltenbach & Voigt GmbH & Co.

(21) Appl. No.: 10/105,680

(22) Filed: Mar. 25, 2002

(30) Foreign Application Priority Data
Mar. 26, 2001 (DE) 101 14 771.6

(51) Int. Cl. B67D 5/06

(52) U.S. Cl. 222/205

(57) ABSTRACT

A dispenser for a fluid cleaning medium (4) for cleaning the suction system (23, 25) and drainage system (29) of a dental treatment station (26) comprises a supply container (2) and a dispensing container (3) which are connected with one another via a pump (6). Upon an actuation of the pump (6) cleaning medium (4) is transported into the dispensing container (3), which medium can be drawn off or dispensed.

The present invention relates to a dispenser for a fluid cleaning medium for cleaning the suction system and drainage system of a dental treatment station.

With dental or medical treatments, spray mists, secretion, blood and solid parts are often drawn off by vacuum. For reasons of hygiene it is thereby necessary, after conclusion of treatment, to clean and to decontaminate the system affected by dirt and germs, in particular the suction hoses of the suction system. For this purpose, cleaning systems are made available by several providers, with which systems first a usable solution is mixed of a cleaning medium concentrate and water. The concentrate may thereby be a powder, a gel or a low viscosity fluid. The containers, in which the cleaning medium is mixed, contain plug-on means for the suction hoses concerned, via which the cleaning liquid can be drawn off and the suction system hereby cleaned.

From DE 40 10 615 C2 there is known a further method for cleaning medical or dental suction devices, in which the cleaning medium is made available in the form of grains of granulate. These grains of granulate are sucked directly through the suction hoses to be cleaned, whereby upon contact with the wetted inner surface of the suction system or drainage system they remain adhered and slowly dissolve in the water film forming the wetting. By these means the cleaning medium spreads within the suction system, so that finally a substantial part of the surface is covered with a highly concentrated cleaning medium, which provides for the desired intensive disinfection.

The object of the present invention is to keep the effort for cleaning a suction and draining system of a dental treatment station as small as possible. Further, a simple but exact dosing of the cleaning medium is to be possible.

This object is achieved by means of a dispenser for a liquid cleaning medium, which has the features of claim 1. The dispenser in accordance with the invention distinguishes itself in that first it has a supply container in which the cleaning medium is arranged. Beyond this, there is further provided a dispensing container with which the supply container is connected via a pump, which upon a corresponding actuation pumps the liquid cleaning medium into the dispensing container. The cleaning medium can then be removed or drawn off or poured from the dispensing container.

The dispenser in accordance with the invention makes it possible to directly employ the cleaning medium located in the supply container, without there previously having to be mixed a cleaning medium of the desired concentration, from a concentrate and water. Beyond this, by means of the pump exact dosing is possible, so that in each case only the quantity of cleaning medium is delivered to the dispensing container which is also needed for the cleaning of the corresponding hose or drain.

Further developments of the invention are the subject of the subclaims.

The pump is preferably a piston pump, as is put to use for the transportation of liquid to pasty media. Thereby, the dispensing container may be rigidly connected with the piston of the pump so that for an actuation of the pump the dispensing container simply has to be pressed down. Depending upon how far down the dispensing container is pressed down, the corresponding quantity of cleaning medium is then pumped into the dispensing container.

The supply container respectively the dispensing container has preferably as least one or more suction tubes to which the hoses of the suction system to be cleaned can be connected. If a plurality of suction tubes are present these are preferably arranged coaxially. Further it may be provided that the dispensing container has a pouring spout or lip. By these means the cleaning medium pumped into dispensing container can also simply be poured into the drainage system to be cleaned.

Below, the invention will be described in more detail with reference to accompanying drawings, which show:

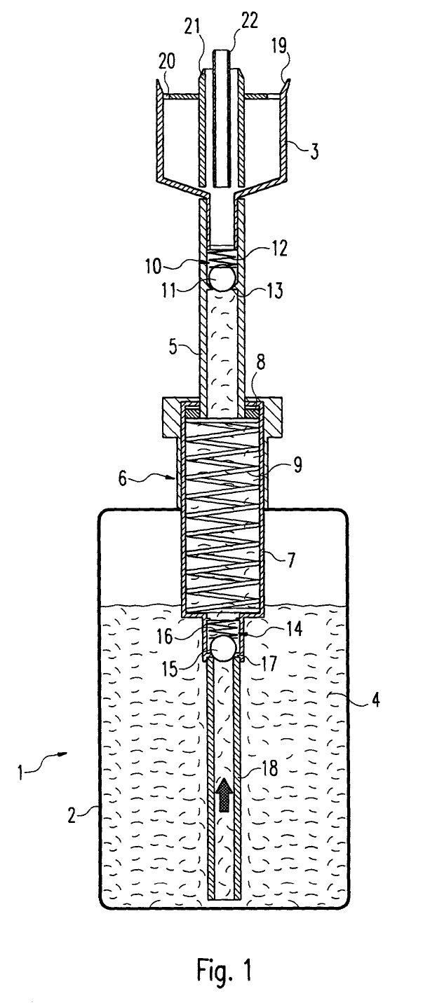

FIG. 1 the dispenser in accordance with the invention, in section;

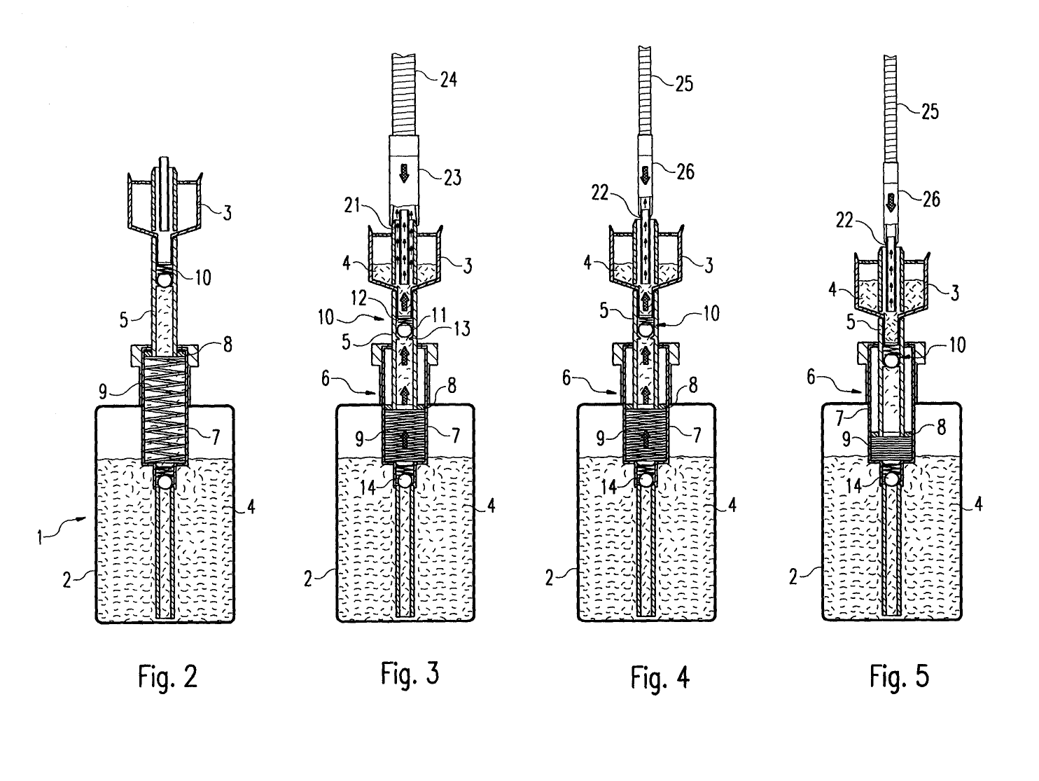

FIGS. 2 to 8 the dispenser illustrated in FIG. 1 in various phases of the dispensing process; and

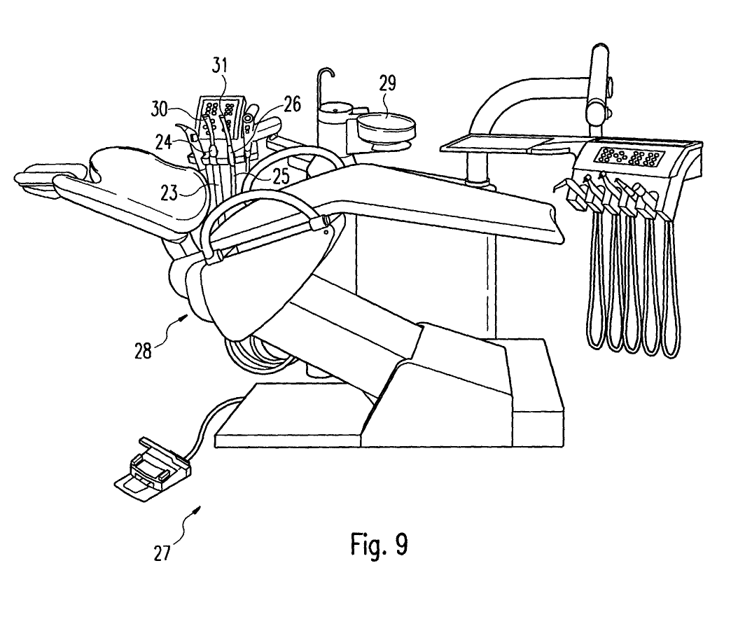

FIG. 9 a dental treatment station, the suction and drainage system of which is to be cleaned with the aid of the dispenser in accordance with the invention.

The dispenser in accordance with the invention is provided in particular for the cleaning of the suction and drainage system of a dental treatment station 27 as schematically illustrated in FIG. 9, which has a dental chair 28 and appropriate dental treatment apparatus. To be cleaned thereby in particular are the rinsing basin 29 and the drainage system, which is formed by means of the suction hoses 23 and 25 of the spray mist hose handpiece 30 or of the saliva drainage hose handpiece 31.

The dispenser 1 provided for this purpose and illustrated in FIG. 1 consists in substance of two parts; a lower part which is formed by means of a supply container 2, and an upper part which is formed by means of a dispensing container 3. The supply container 2 thereby serves to hold a large quantity of the cleaning medium 4, which is a liquid—preferably with middle viscosity characteristics—or a gel.

The supply container 2 and the dispensing container 3 are connected via a hand dispensing pump 6 in the form of a piston pump, such as is put to use for delivery of media from liquid to pasty. Within the pump housing 7 there is movably arranged a piston 8 which is biased upwardly by means of a return spring 9. The upper exit of the pump housing 7 is connected with the dispensing container 3 via a connection line 5 in the form of a rigid pipe. Within the connection pipe 5 there is arranged an upper non-return valve 10 which is formed by means of a ball 11 biased downwardly by a spring 12 against a stop 13, against the transport direction of the pump 6.

A further, lower non-return valve 14, which is constructed in the same manner as the upper non-return valve 10, is arranged in the entry to the pump housing 7 and serves for opening or blocking a suction pipe 18 extending into the supply container 1.

Within the dispensing container 3 there are arranged two suction tubes 21 and 22, which have such a diameter that they can be connected with the hoses of the suction system which are to be cleaned. In this way, for cleaning a hose, the cleaning medium arranged within the dispensing container 3 can be drawn off. Furthermore, the dispensing container 3 has on one side a pouring spout or lip 19 through which for example the cleaning medium located in the dispensing container 3 can be poured for cleaning the rinsing basin. Finally, there is provided at the upper side of the dispensing container 3 a venting bore 20.

With reference to FIGS. 2 to 8, the manner of functioning of the pump 6 and of the overall dispenser 1 will be explained. Thereby, various Figures show the individual phases of a dispensing procedure.

FIG. 2 shows the initial condition of the dispenser 1, before a dispensing procedure. In this initial position, the piston 8 is pressed upwardly by means of the return spring 9 as far as its upper end position within the pump housing 7. The pump housing 7 is thereby completely filled with the cleaning medium 4. Further, also the suction pipe 18 and the connection pipe 5 are filled with the cleaning medium 4 from the upper side of the pump housing 7 up to is the upper non-return valve 10.

If for example—as illustrated in FIG. 3—the hose 23 of a spray mist hose handpiece is to be cleaned—this is connected via its coupling piece 24 with the suction tube 21 of the dispensing container 3. Then, the dispensing container is pressed down together with the pump piston 8 against the force of the bias spring 9, which can be effected for example by means of a pressing down of the coupling piece 24.

Through the pressing down of the piston 8, the volume of the piston chamber is reduced, so that the cleaning medium 4 arranged therein flows upwardly in the direction of the dispensing container 3. Thereby, the ball 11 of the upper non-return valve 10 is pressed upwardly, so that the valve 10 automatically opens. The cleaning medium 4 flowing into the dispensing container 3 is then drawn off through the hose 23 so that this is cleaned. The lower non-return valve 14 remains closed during this procedure. FIG. 4 shows the same step in the case of a cleaning of a hose 25 of the saliva drainage hose handpiece. Here, the thinner hose 25 is connected with the inner suction pipe 22 via its coupling piece 26.

How much cleaning medium 4 is transported into the dispensing container 3 depends upon the height of the piston stroke. Thus there is the possibility of exactly dosing the quantity of the cleaning medium 4 in that the piston 8 is pressed down by exactly the height corresponding to the desired quantity. For example, for this purpose a scale may a applied to the outside, which indicates the piston stroke needed to transport particular quantities of cleaning medium.

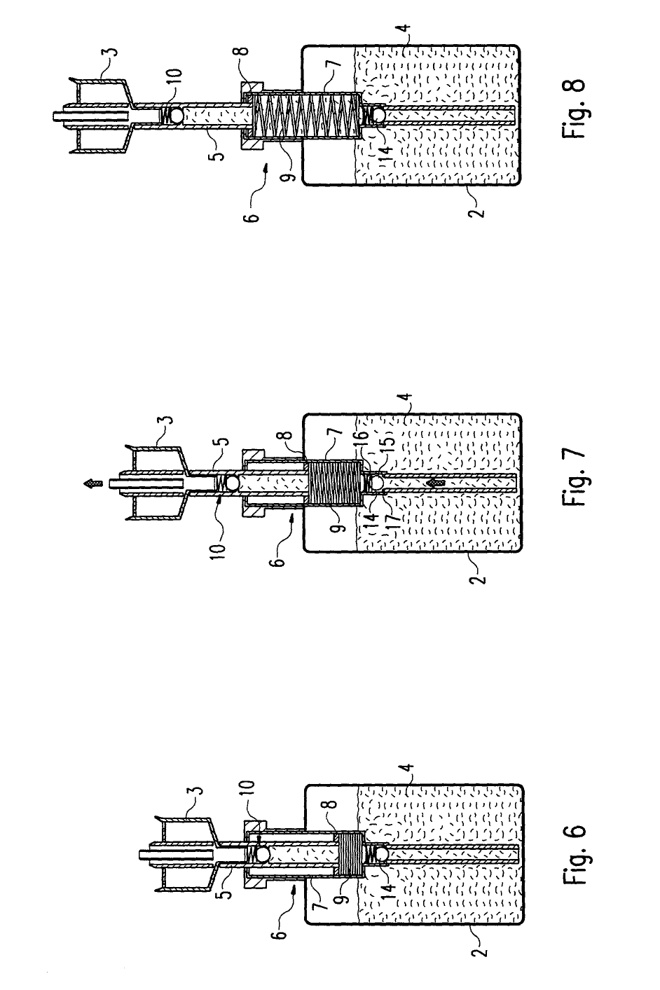

The maximum quantity of cleaning medium for a dispensing procedure can be transported into the dispensing container 3 when the piston 8 is completely pressed down. If the piston 8 is pressed down by the desired height or completely, the upper non-return valve 10 closes automatically—as shown in FIG. 5—so that despite the suction force of the hose 25 to be cleaned no further cleaning medium can be drawn off out of the piston chamber 7 or the supply container 4. As is illustrated in FIG. 6, the cleaning medium is drawn off at most up to the now closed upper non-return valve 10. In this phase, the upper non-return valve 14 is, as before, closed.

Instead of the above described connection of a suction hose and the subsequent pressing down of the piston 8 for pumping the cleaning medium 4, alternatively also the dispensing container 3 may initially be pressed down, in order to transport a desired quantity of cleaning medium. This cleaning medium 4 can then for example be poured out via the pouring spout 19 in order, for example, to clean the rinsing basin. There exists also the possibility to draw off the transported cleaning medium 4 with a suction hose only after the pumping of the cleaning medium 4 into the dispensing container 3.

After the partly or completely pressed down piston 8 is released, it is again automatically pressed upwardly by means of the return spring 9. Through this there arises within the pump chamber 7 an under-pressure, so that the lower non-return valve 14 automatically opens and the cleaning medium 4 located in the supply container 2 flows upwardly into the pump chamber 7 via the suction pipe 18. Only when the piston 8 is pushed fully upwardly, and the pump chamber 7 is again filled with the cleaning medium, does the lower non-return valve automatically close, so that the end disposition illustrated in FIG. 8 is provided, which is identical with the initial disposition illustrated in FIG. 2.

The illustrated dispenser thus makes possible in a simple manner an exact dosing of the cleaning medium, so that exactly the quantity needed for cleaning a particular apparatus can be made available. Further, it is not necessary first to mix a cleaning medium of the desired concentration with the aid of a concentrate. Rather, the cleaning medium arranged in the supply container can be directly employed, so that the effort for cleaning a suction and/or drainage system is extremely small.

1. Dispenser for a fluid cleaning medium (4) for cleaning the suction system (23, 25) and drainage system (29) of a dental treatment station (27), characterized in that,
this has a supply container (2) and a dispensing container (3), the dispensing container (3) being connected with the supply container (2) via a pump (6) which upon its actuation pumps cleaning medium (4) into the dispensing container (3).

2. Dispenser according to claim 1, characterized in that,
the pump (6) is a piston pump.

3. Dispenser according to claim 2, characterized in that,
the piston (8) of the pump (6) is rigidly connected with the dispensing container (3), whereby for actuation of the pump (6) the dispensing container (3), connected with the piston (8), is to be pressed down.

4. Dispenser according to claim 2, characterized in that,
the piston (8) of the pump (6) is biased by means of a return spring (9).

5. Dispenser according to claim 1, characterized in that,
a non-return valve (10) is arranged in a connection line (5) arranged between the pump (6) and the dispensing container (3), which non-return valve automatically opens upon an actuation of the pump (6).

6. Dispenser according to claim 1, characterized in that,
a further non-return valve (14) is arranged in a suction pipe (18) connecting the pump (6) with the supply container (2).

7. Dispenser according to claim 1, characterized in that,
at least one suction tube (21) is arranged on the dispensing container (3), to which suction tube a hose (23) of the suction system to be cleaned can be connected.

8. Dispenser according to claim 7, characterized in that,
a further suction tube (22) is arranged on the dispensing container (3), to which further suction tube a hose (24) of the suction system to be cleaned can be connected, whereby the two suction tubes (22, 23) have different diameters.

9. Dispenser according to claim 8, characterized in that,
the two suction tubes (22, 23) are arranged coaxially.

10. Dispenser according to claim 1, characterized in that,
the dispensing container (3) has a pouring spout (19).
